(19) United States
(12) Patent Application Publication
(10) Pub. No.: US 2026/0129322 A1
(43) Pub. Date: May 7, 2026

(54) NODE FOR A MULTI-PLANE OPTICAL NETWORK

(71) Applicant: HUAWEI TECHNOLOGIES CO., LTD., Shenzhen (CN)

(72) Inventors: Gabriel Charlet, Boulogne Billancourt (FR); Yvan Pointurier, Boulogne Billancourt (FR)

(73) Assignee: HUAWEI TECHNOLOGIES CO., LTD., Shenzhen (CN)

(21) Appl. No.: 19/437,980

(22) Filed: Dec. 31, 2025

Related U.S. Application Data
(63) Continuation of application No. PCT/EP2023/078396, filed on Oct. 12, 2023.

(51) Int. Cl. H04Q 11/00

(52) U.S. Cl. CPC H04Q 11/0067; H04Q 11/0005; H04Q 2011/0016; H04Q 2011/0073; H04Q 2213/13164

(57) ABSTRACT

A node for a multi-plane optical network is optically connectable, for each node of at least two other nodes of the multi-plane optical network through respectively two or more optical links to the other node. The node includes one or more wavelength selective switches (WSSs) having a set of ports. The node receives, with a port, an optical signal from an optical link of a first other node. The one or more WSSs provide at least a frequency sub-band of the optical signal from the port through another port to another optical link of the first other node or a second other node. The optical link and the another optical link are associated with one plane and one other plane of the multi-plane optical network, respectively.

### CROSS-REFERENCE TO RELATED APPLICATIONS

This application is a continuation of International Application No. PCT/EP2023/078396, filed on Oct. 12, 2023, the disclosure of which is hereby incorporated by reference in its entirety.

### FIELD

The present disclosure relates to a node in a multi-plane optical network.

### BACKGROUND

In optical networks, data is carried by services over wavelengths, which are then multiplexed over fibers and/or optical links between nodes that perform wavelength-routing. As traffic demand is increasing and single fiber capacity becomes insufficient, the development of parallel fiber systems increases, where optical links between nodes comprise several fibers or optical sub-links.

### SUMMARY

The present disclosure provides enabling optical signals to flexibly switch planes in a multi-plane optical network. Further implementations may decrease service blocking probability during provisioning or rerouting of optical signals.

This disclosure is based on the following considerations.

The size of the nodes, for example, the number of ports, i.e., number of fibers or optical links connected to the node, in optical networks is highly heterogeneous. Some nodes, denoted as “primary nodes” or “main nodes”, for example, nodes in large cities, may have larger sizes while other nodes, denoted here as “secondary nodes”, for example, nodes in small cities, may have smaller sizes. Stacking parallel networks to build a multi-fiber network may strain the main nodes due to constraints on the routing element size (the number of ports of the wavelength selective switches (WSSs) is limited) while such constraint may not exist on the secondary nodes.

The node complexity (size) could be distributed across all nodes. For example, some of the complexity may be moved from the main nodes to the secondary nodes. Exemplary, the size of the main nodes may be limited and thereby constrained in terms of routing/provisioning flexibility), wherein the size of the secondary nodes may be increased, so that the main node size constraint can be mitigated through additional flexibility (and complexity) at the secondary nodes.

Alternatively or additionally, the size of the main nodes may be large enough to provide additional flexibility.

A first aspect of this disclosure provides a node for a multi-plane optical network, wherein the node is optically connectable, for each other node of at least two other nodes of the multi-plane optical network, through respectively two or more optical links to the other node, wherein the node comprises one or more WSSs comprising a set of ports, wherein the node is configured to receive, with a port of the set of ports, an optical signal from an optical link of the respectively two or more optical links of a first other node of the at least two other nodes, wherein the optical link is associated with one plane of the multi-plane optical network, wherein the one or more WSSs are configured to provide at least a frequency sub-band of the optical signal from the port through another port of the set of ports to another optical link of the respectively two or more optical links of the first other node or a second other node of the at least two other nodes, wherein the another optical link is associated with one other plane of the multi-plane optical network. Thus, flexibility of providing the optical signal may be improved, as plane changes are enabled.

The node may be a secondary node or a primary node.

No components of a new type may be required. For example, rewiring may be required, while other hardware of the node may stay the same compared to a conventional node. The node may be for flexibly providing optical signals to other nodes and/or planes in a multi-plane optical network.

Each other node of the at least two other nodes may be optically connected or optically connectable to the node through the two or more respective optical links of the other node extending from the other node, wherein each optical link of the two or more respective optical links may be for or associated with a respective plane of the multi-plane optical network.

For each other node of the at least two other nodes, the respectively two or more optical links may form a subset of optical links. A set of optical links may comprise the subset of optical links of each other node of the at least two other nodes.

Each optical link of the set of optical links may optionally be referred as an “optical sub-link” instead of an “optical link”. For each subset of optical links in the set of optical links, the subset of optical links may form a respective optical link, which may be referred to as a “respective composite optical link”, comprising the respectively two or more optical sub-links.

For example, each respective composite optical link may optically connect the node to a respective other node of the at least two other nodes. Each composite optical link may be for or associated with two or more planes of the multi-plane optical network. Each optical sub-link may be for or associated with one respective plane of the multi-plane optical network.

For example, each optical sub-link may be one connection, for example one fiber, between the node and a particular node of the at least two other nodes. For example, each optical sub-link may be associated with an exemplary plane and an exemplary degree.

The multi-plane optical network may be referred to as a parallel fiber optical network. The multi-plane optical network may comprise a plurality of planes. Each plane of the plurality of planes may be a network-wide plane. For example, different planes of the plurality of planes may be operating primarily in parallel in the network. Each plane of the plurality of planes may be associated with a respective type of traffic. For example, each plane of the plurality of planes may be primarily dedicated to a respective type of traffic of the plane. For example, a subset of nodes may be configurable to provide plane changes in the multi-plane optical network. For example, the multi-plane optical network may comprise at least one node that receives two or more optical signals, each optical signal being associated with a respective plane of the plurality of planes, wherein the two or more optical signals and the receptive planes may be optically disconnected from each other in the at least one node.

In an implementation form of the first aspect, the one or more WSSs are further configured to provide at least another frequency sub-band of the optical signal from the port through a further port of the set of ports to a further optical link of the respectively two or more optical links of the second other node or a third other node of the at least two other nodes, wherein the further optical link is associated with the one plane of the multi-plane optical network. For example, the at least two other nodes may be at least three other nodes.

Different sub-bands of an optical signal may be provided to optical links associated with different planes. Thus, plane changes can be enabled.

In a further implementation form of the first aspect, the node is further configured to receive, with the port, another optical signal from the optical link, wherein the one or more WSSs are further configured to provide at least a frequency sub-band of the another optical signal from the port through a further port of the set of ports to a further optical link of the respectively two or more optical links of the second other node or a third other node of the at least two other nodes, wherein the further optical link is associated with the one plane of the multi-plane optical network. Different optical signals originally associated with a same plane may be provided to optical links associated with different planes. Thus, plane changes can be enabled.

In a further implementation form of the first aspect, the node is further configured to receive, with an even further port, a further optical signal from an even further optical link, wherein the one or more WSSs are further configured to provide at least a frequency sub-band of the further optical signal from the even further port through the another port to the another optical link of the respectively two or more optical links of the second other node, wherein the even further optical link is associated with the one other plane of the multi-plane optical network. Different optical signals originally associated with different planes may be provided to the same optical link. Thus, plane changes can be enabled.

In a further implementation form of the first aspect, the node further comprises a controller, wherein the controller is configured to control the one or more WSSs to provide at least one of: the at least frequency sub-band of the optical signal to the another optical link, the at least another frequency sub-band of the optical signal to the further optical link, and the at least frequency sub-band of another optical signal to the further optical link. The controller may be configured to control the one or more WSSs to provide the at least frequency sub-band of the further optical signal to the another optical link.

In a further implementation form of the first aspect, the controller is configured to obtain a network traffic routing plan for distributing traffic across a plurality of planes of the multi-plane optical network, wherein the controller is configured to control the one or more WSSs based on the network traffic routing plan. Thus, the optical network may be able to provide traffic more efficiently, wherein the capacity of more optical links can be utilized without exhausting the capacity of one particular optical link. The controller may be configured to select the another port and/or the further port from the set of ports by using the network traffic routing plan.

For example, the controller may be configured to control the one or more WSSs based on the network traffic routing plan to provide the at least frequency sub-band of the optical signal from the port through the another port to the another optical link of the respectively two or more optical links of the second other node or the third other node, for example, instead of through the further port to the further optical link.

For example, the node may be configured to provide plane changes if traffic can be distributed more efficiently across different optical links.

In a further implementation form of the first aspect, the one or more WSSs are configurable to optically connect each port of the set of ports to each other port of the set of ports. The one or more WSSs can or may be able to optically connect each port of the set of ports. For example, any port of the node may be able to be optically connected to any other port of the node. For example, any plane or optical link of the first other node may be able to be optically connected through the node to any plane or optical link of the second other node.

In a further implementation form of the first aspect, the set of ports comprises at least one drop port configured to remove one or more selected wavelengths from the optical signal and provide the one or more selected wavelengths to one or more local receivers at the node; and/or wherein the set of ports comprises at least one add port configured to provide one or more additional wavelengths from one or more local transmitters into the at least a frequency sub-band of the optical signal. For example, each WSS of the set of WSSs may comprise one or more ports for add and/or drop operations.

In a further implementation form of the first aspect, the one or more WSSs are configured to provide the at least frequency sub-band of the optical signal from the port through a fiber switch or a plurality of wires, and through the another port to the another optical link.

In a further implementation form of the first aspect, the two or more other nodes are directly optically connected by at least one optical link.

A second aspect of this disclosure provides a multi-plane optical network comprising the node according to any one of the preceding claims, the at least two other nodes, and, for each other node of the at least two other nodes, the respectively two or more optical links that optically connect the other node to the node, wherein the optical network is configured to: receive the optical signal with the first other node of the at least two other nodes, and provide the optical signal through the optical link of the respectively two or more optical links of the first other node to the port of the set of ports.

In an implementation form of the second aspect, the optical network is further configured to provide the at least frequency sub-band of the optical signal through the another optical link to the first other node or the second other node.

In a further implementation form of the second aspect, the at least two other nodes comprise one or more other secondary nodes.

In a further implementation form of the second aspect, the one or more other secondary nodes comprise a plurality of sub-nodes that are optically isolated from each other in respectively the other secondary node, each sub-node being associated with a respective plane of the multi-plane optical network, and/or wherein the one or more other secondary nodes comprise one or more nodes according to the first aspect or any of its implementation forms.

In a further implementation form of the second aspect, the at least two other nodes comprise one or more other primary nodes, each other primary node comprising a plurality of sub-nodes that are optically isolated from each other in respectively the other primary node, each sub-node being associated with a respective plane of the multi-plane optical network. For example, the one or more other primary nodes may be two or more other primary nodes.

For example, in a particularly other secondary node or primary node, each plane of the multi-plane optical network may be optically disconnected and/or separated from each other plane of the multi-plane optical network.

Any sub-node of the first other node may be able to communicate with any sub-node of the second other node.

In a further implementation form of the first aspect, the one or more other primary nodes comprise at least one of: the first other node, the second other node, and the third other node.

In a further implementation form of the second aspect, the one or more other secondary nodes comprise at least one of: the first other node, the second other node, and the third other node.

In a further implementation form of the second aspect, the node is embedded with a other primary node of the one or more other primary nodes forming a combined node. For example, the node may be a secondary node and may be embedded with the other primary node.

In a further implementation form of the second aspect, each node of the one or more other primary nodes has higher traffic than the node, for example, if the node is a secondary node, and/or each node of the one or more other secondary nodes.

In a further implementation form of the second aspect, the node, for example, if the node is a primary node, has higher traffic than each node of the one or more other nodes. Each node of the one or more other primary nodes may have more degrees than the node, if the node is a secondary node, and/or each node of the one or more other nodes. The node, if the node is a primary node, may have more degrees than each node of the one or more other secondary nodes. Each sub-node of the plurality of sub-nodes may be a ROADM.

The multi-plane optical network of the second aspect may have implementation forms that correspond to the implementation forms of the node of the first aspect. The multi-plane optical network of the second aspect and its implementation forms achieve the advantages and effects described above for the node of the first aspect and its respective implementation forms.

A third aspect of this disclosure provides a method of operating a node for a multi-plane optical network, wherein the node is optically connectable, for each other node of at least two other nodes of the multi-plane optical network, through respectively two or more optical links to the other node, wherein the node comprises one or more WSSs comprising a set of ports, wherein the method comprises: receiving, with a port of the set of ports, an optical signal from an optical link of the respectively two or more optical links of a first other node of the at least two other nodes, wherein the optical link is associated with one plane of the multi-plane optical network, and providing, with the one or more WSSs, at least a frequency sub-band of the optical signal from the port through another port of the set of ports to another optical link of the respectively two or more optical links of the first other node or a second other node of the at least two other nodes, wherein the another optical link is associated with one other plane of the multi-plane optical network.

The method of the third aspect may have implementation forms that correspond to the implementation forms of the node of the first aspect. The method of the third aspect and its implementation forms achieve the advantages and effects described above for the node of the first aspect and its respective implementation forms.

A fourth aspect of this disclosure provides a method of operating a multi-plane optical network comprising the method according to the third aspect, wherein the multi-plane optical network comprises the node, the at least two other nodes, and, for each other node of the at least two other nodes, the respectively two or more optical links that optically connect the other node to the node, wherein the method further comprises: receiving the optical signal with the first other node of the at least two other nodes, and providing the optical signal through the optical link of the respectively two or more optical links of the first other node to the port of the set of ports.

The method of the fourth aspect may have implementation forms that correspond to the implementation forms of the multi-plane optical network of the second aspect and the node of the first aspect. The method of the fourth aspect and its implementation forms achieve the advantages and effects described above for the multi-plane optical network of the second aspect, the node of the first aspect, and its respective implementation forms.

Further, in this disclosure the phrase “primary node” and “main node” may be used interchangeably.

Further, in this disclosure, a “first” element and a “second” element are considered to be different components. For example, a “first other node” and a “second other node” are considered to be different nodes.

It has to be noted that all devices, elements, units and means described in the disclosure could be implemented in the software or hardware elements or any kind of combination thereof. All steps which are performed by the various entities described in the disclosure as well as the functionalities described to be performed by the various entities are intended to mean that the respective entity is adapted to or configured to perform the respective steps and functionalities.

Even if, in the following description of exemplary embodiments, a functionality or step to be performed by external entities is not reflected in the description of a detailed element of that entity which performs that step or functionality, it should be clear for a skilled person that these methods and functionalities can be implemented in respective software or hardware elements, or any kind of combination thereof.

### DESCRIPTION OF DRAWINGS

The above described aspects and implementation forms will be explained in the following description of exemplary embodiments in relation to the enclosed drawings, in which the same or similar reference numerals designate the same or similar elements.

FIG. 1 shows a node for a multi-plane optical network, according to one or more embodiments of the present disclosure.

FIG. 2 shows an exemplary node for a multi-plane optical network, according to one or more embodiments of the present disclosure.

FIG. 3 shows an exemplary ROADM based optical network comprising a plurality of planes, according to one or more embodiments of the present disclosure.

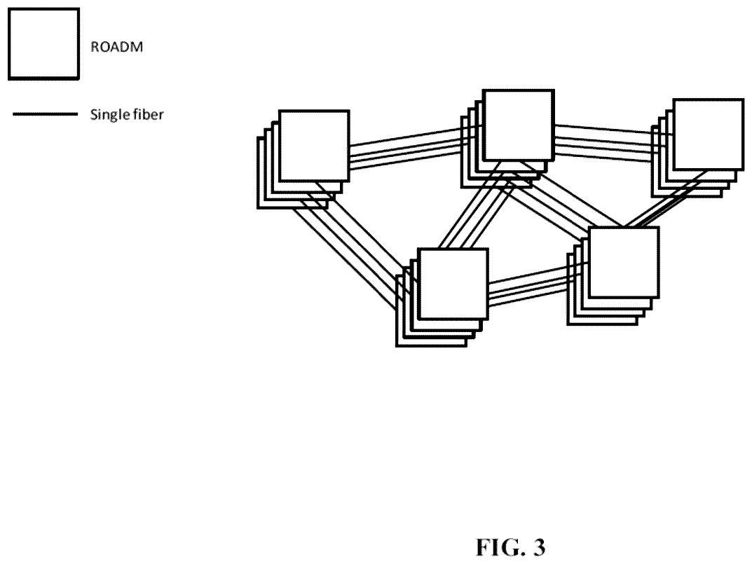

FIG. 4 shows an exemplary multi-plane optical network, according to one or more embodiments of the present disclosure.

FIG. 5 shows another exemplary multi-plane optical network, according to one or more embodiments of the present disclosure.

FIG. 6 shows an exemplary secondary node in an optical network, according to one or more embodiments of the present disclosure.

FIG. 7 shows a conventional degree 2 node for M=4 fibers, according to one or more embodiments of the present disclosure.

FIG. 8 shows a degree 2 node for M=4 fibers, according to one or more embodiments of the present disclosure.

FIG. 9 shows a conventional 3 degree node for M=2 fibers, according to one or more embodiments of the present disclosure.

FIG. 10 shows a 3 degree node for M=2 fibers, according to one or more embodiments of the present disclosure.

FIG. 11 shows an exemplary combined node in an optical network, according to one or more embodiments of the present disclosure.

FIG. 12 shows an exemplary combined node, according to one or more embodiments of the present disclosure.

FIG. 13 shows a node comprising a fiber switch, according to one or more embodiments of the present disclosure.

FIG. 14 shows an optical network, according to one or more embodiments of the present disclosure.

FIG. 15 shows a method, according to one or more embodiments of the present disclosure.

FIG. 16 shows another method, according to one or more embodiments of the present disclosure.

### DETAILED DESCRIPTION

Embodiments of the present disclosure provide a node, a multi-plane optical network comprising the node, a corresponding method of operating the node, and a corresponding method of operating the multi-plane optical network. The node provides optical signals to other nodes in the multi-plane optical network in a new kind of way.

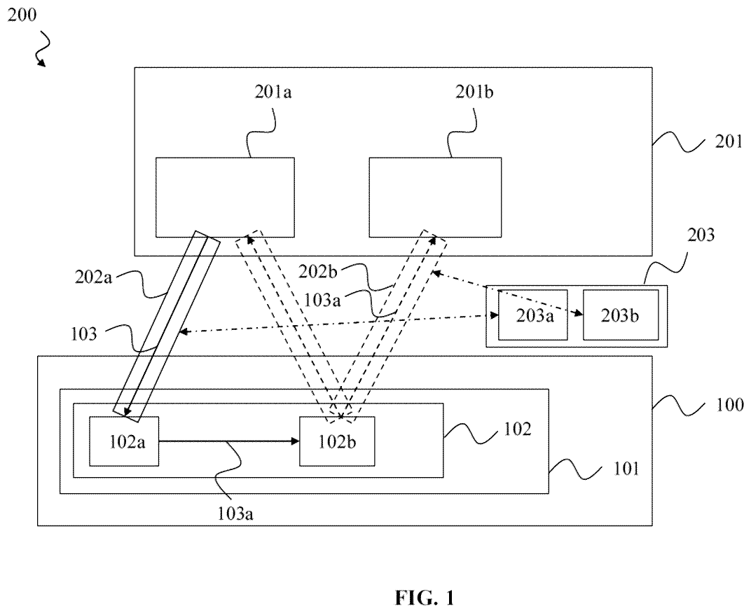

FIG. 1 shows a node 100 for a multi-plane 203 optical network 200 according to this disclosure. The node 100 comprises one or more WSSs 101 comprising a set of ports 102.

FIG. 1 shows an exemplary multi-plane 203 optical network 200, which the node 100 is for, comprising the node 100 and at least two other nodes 201, and, for each other node of the at least two other nodes 201, respectively two or more optical links.

The node 100 is optically connectable or optically connected, for each other node of the at least two other nodes 201, through respectively two or more optical links to the other node.

The node 100 is configured to receive, with a port 102a of the set of ports 102, an optical signal 103 from an optical link 202a of the respectively two or more optical links of a first other node 201a of the at least two other nodes 201.

The one or more WSSs 101 are configured to provide at least a frequency sub-band of the optical signal 103a from the port 102a through another port 102b of the set of ports 102 to another optical link 202b of the respectively two or more optical links of the first other node 201a or a second other node 201b of the at least two other nodes 201. The another optical link 202b is shown as two dashed boxes in FIG. 1, as the another optical link 202b is either of the first other node 201a or of the second other node 201b. For example, the another optical link 202b optically connects or is optically connectable to the first other node 201a if the another optical link 202b is of the first other node 201a. In another example, the another optical link 202b optically connects or is optically connectable to the second other node 201b if the another optical link 202b is of the second other node 201b.

The optical link 202a is associated with one plane 203a of the multi-plane 203 optical network 200, and the another optical link 202b is associated with one other plane 203b of the multi-plane 203 optical network 200, which is indicated by the dot-dashed lines in FIG. 1.

The node 100 may be a primary node or a secondary node.

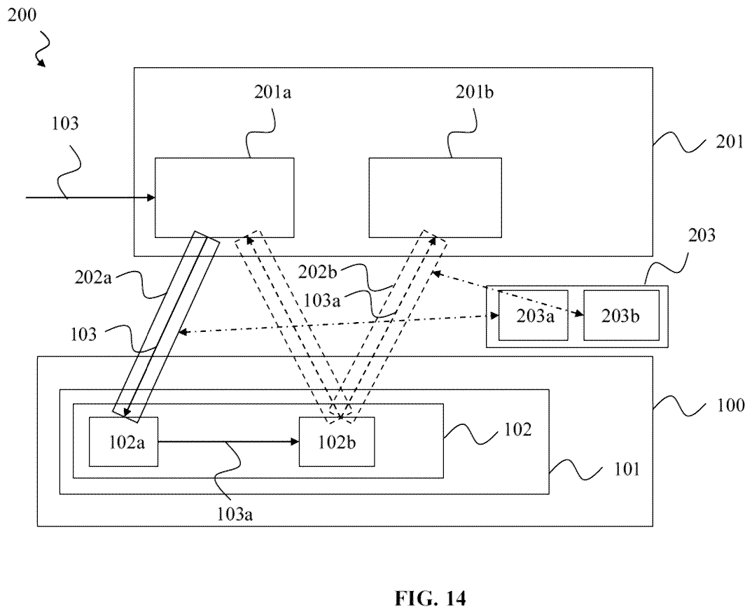

FIG. 14 shows an optical network 200 according to this disclosure. The optical network 200 comprises the node 100 shown in FIG. 1, the at least two other nodes 201, for example, as shown in FIG. 1, and, for each other node of the at least two other nodes 201, the respectively two or more optical links that optically connect the other node to the node 100, for example, as shown in FIG. 1.

The optical network 200 is configured to receive the optical signal 103 with the first other node 201a of the at least two other nodes 201, and provide the optical signal 103 through the optical link 202a of the respectively two or more optical links of the first other node 201a to the port 102a of the set of ports 102.

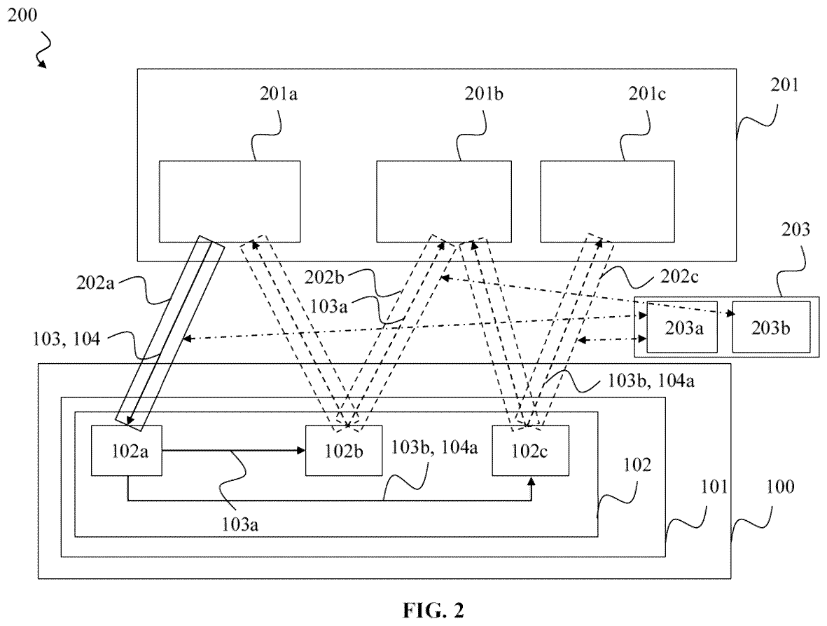

FIG. 2 shows an exemplary node 100 for a multi-plane 203 optical network 200 according to this disclosure. FIG. 2 shows the node 100 of FIG. 1 comprising additional components. The one or more WSSs 101 may be further configured to provide at least another frequency sub-band of the optical signal 103b from the port 102a through a further port 102c of the set of ports 102 to a further optical link 202c of the respectively two or more optical links of the second other node 201b or a third other node 201c of the at least two other nodes 201.

Alternatively or additionally, FIG. 2 shows that the node 100 of FIG. 1 may be further configured to receive, with the port 102a, another optical signal 104 from the optical link 202a, wherein the one or more WSSs 101 may be further configured to provide at least a frequency sub-band of the another optical signal 104a from the port 102a through the further port 102c of the set of ports 102 to the further optical link 202c of the respectively two or more optical links of the second other node 201b or the third other node 201c.

The further optical link 202c may be associated with the one plane 203a of the multi-plane 203 optical network 200, which is indicated by the dot-dashed lines in FIG. 2. The further optical link 202c may be associated with the one plane 203a of the multi-plane 203 optical network 200. The further optical link 202c is shown as two dashed boxes in FIG. 2, as the further optical link 202c is either of the second other node 201b or of the third other node 201c. For example, the further optical link 202c may optically connect or be optically connectable to the second other node 201b if the further optical link 202c is of the second other node 201b. In another example, the further optical link 202c may optically connect or be optically connectable to the third other node 201c if the another optical link 202b is of the third other node 201c.

This disclosure may improve the optical network 200 scalability when fibers or optical sub-links are added to composite optical links between optical nodes.

This disclosure may provide a multi-plane 203 optical network 200 architecture where optical nodes are connected by composite optical links comprising multiple fibers or optical sub-links, wherein some nodes may be made of independent ROADMs (the “main nodes”), and others may be made of standard ROADMs (the “secondary nodes”).

In some embodiments, a plane change may be possible at the nodes 100. In some embodiments, a main node and a node 100 may be combined to build a new “combined node” to provide a main node that has the advantages of the node 100. In some embodiments the node 100 may be a main node to provide a main node that has the advantages of the node 100.

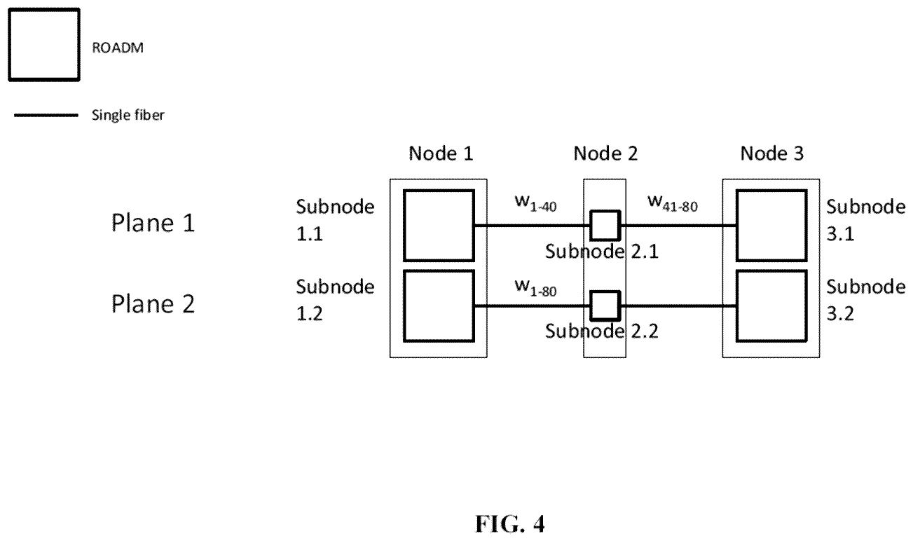

FIG. 4 shows an exemplary multi-plane 203 optical network 200. In this example, nodes 1 and 3 are carrying a large amount of traffic, denoted as “main nodes”, and implemented as stacked sub-nodes. The sub-nodes are independent from each other in the main node. For example, no plane switching can be performed in the main node. Each sub-node may be a ROADM. Between primary nodes may be one or more secondary nodes which add/drop a low amount of traffic.

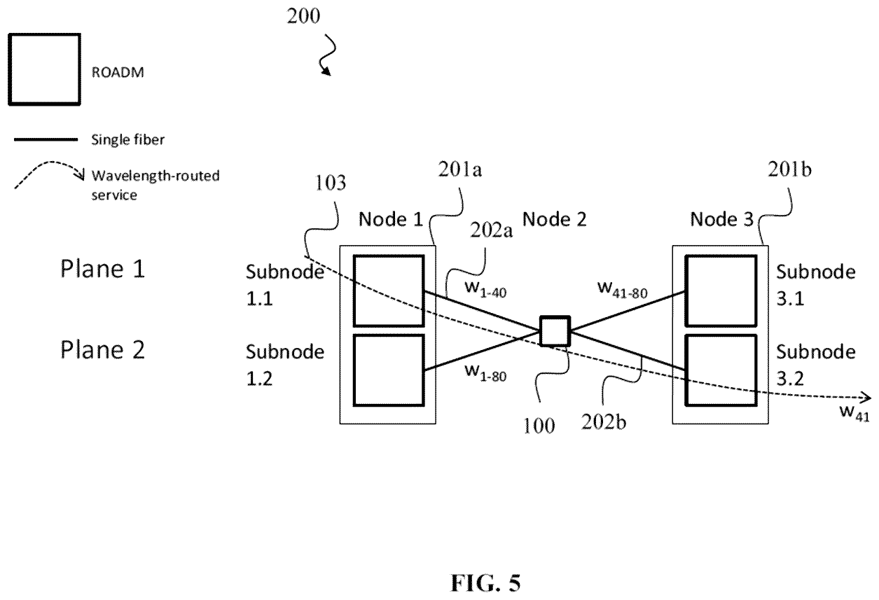

FIG. 5 shows an exemplary multi-plane 203 optical network 200 according to this disclosure. FIG. 5 shows an optical network 200 comprising a secondary node 100, a first other node 201a, and a second other node 201b, wherein the secondary node 100 provides the optical signal 103 from an optical link 202a of the first other node 201a to another optical link 202b of the second other node 201b.

In this example, the first other node 201a and the second other node 201b comprises two sub-nodes, respectively. Each sub-node may be associated with one plane of the multi-plane 203 optical network 200. Any sub-node of the first other node 201a (Node 1) may be able to communicate through the secondary node 100 with any sub-node of the second other node 201b (Node 2).

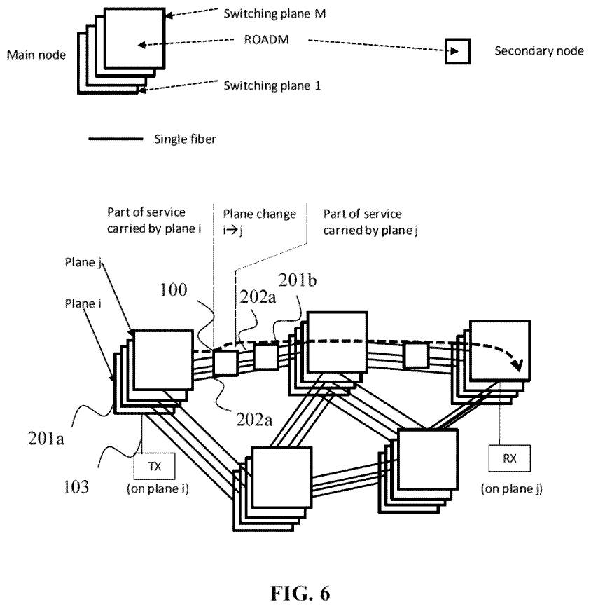

FIG. 6 shows an exemplary secondary node 100 in an optical network 200 according to this disclosure. FIG. 6 shows an optical network 200 comprising the secondary node 100, a first other node 201a, and a second other node 201b, wherein the secondary node 100 optically connects an optical link 202a of the first other node 201a to another optical link 202b of the second other node 201b. In this example, the first other node 201a is one other primary node, and the second other node 201b is one other secondary node. In this example, a service or optical signal 103 changes plane from plane i to plane j in the secondary node 100.

A node 100 may be implemented with degree M+K WSS, where M is the number of parallel fibers reaching/leaving the node 100, and K is the number of ports 102a reserved for service add/drop operations. K may or may not be the same for each of the M degrees.

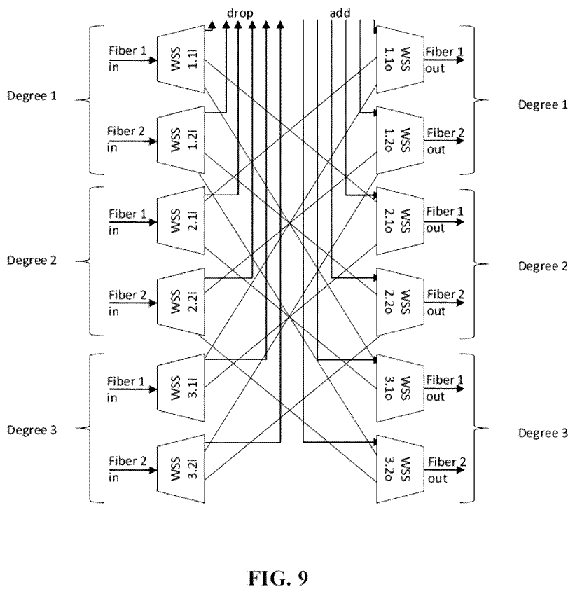

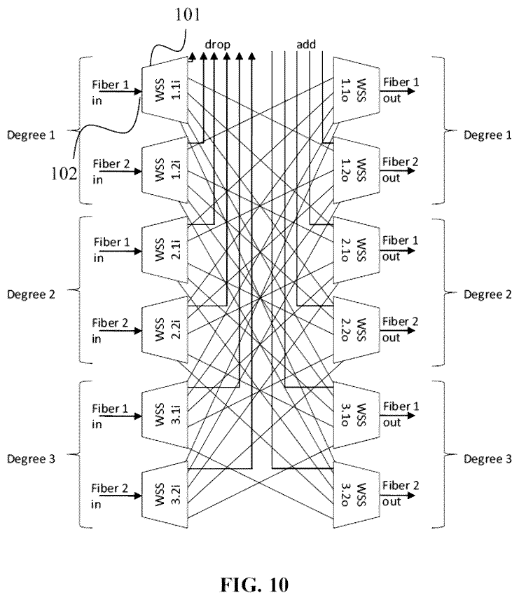

The largest nodes of the main nodes may be of the same size and hence meet the WSS size constraint. The nodes 100 may maintain a relatively low requirement in terms of WSS size (M+K, for example, where M may be 4-16 and K may be 1-4), well below physical limitations. A conventional stacked node architecture would require 4 nodes of small degree to implement the node 100. The node 100 may require a single, slightly larger node. However, given the typical size of WSSs used even for a small-degree node, e.g., 1×9, a conventional secondary node and the secondary node 100 may require exactly the same hardware, wherein the secondary node 100 may require more internal wiring (see, for example, FIGS. 9 and 10).

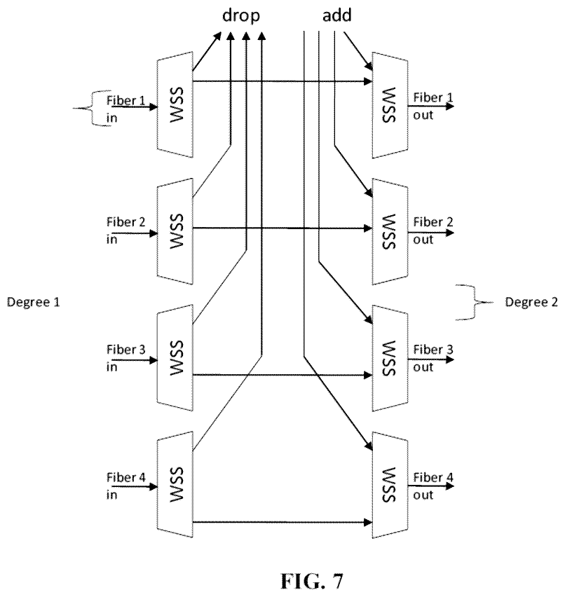

In the following embodiments of the FIGS. 7 to 10 each “fiber” is associated with and/or represents a respective plane, and each degree represents one other node of the at least two other nodes 201.

FIG. 7 shows a conventional degree 2 node for M=4 fibers. FIG. 7 shows a node that is not able to provide a plane change for an optical signal, as each fiber is optically connected, except for add/drop connections, to another fiber of a same plane.

The secondary node shown in FIG. 7 may be referred to as a “stacked” secondary node.

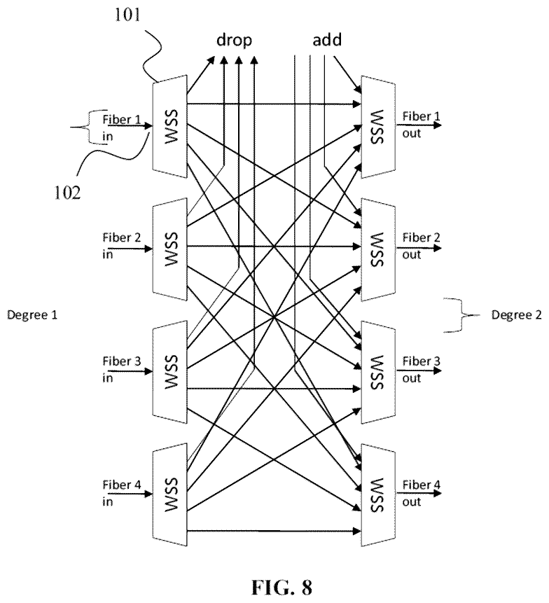

FIG. 8 shows a degree 2 node 100 for M=4 fibers according to this disclosure. FIG. 8 shows a node 100 that is able to provide a plane change for an optical signal, as each fiber is optically connected to each other fiber. The additional optical connections shown in FIG. 8 compared to FIG. 7 illustrate an increased routing flexibility of the node 100. For example, each port of the set of ports 102 of the one or more WSSs 101 is optically connected to each other port.

FIGS. 7 and 8 show 1 direction for the optical signal, wherein a second direction may be identical.

Some nodes 100 may have degree of 3 or more.

FIG. 9 shows a conventional 3 degree node for M=2 fibers. FIG. 9 shows a node that is not able to provide a plane change for an optical signal, as each fiber is optically connected, except for add/drop connections, to another fiber of a same plane.

FIG. 10 shows a 3 degree node 100 for M=2 fibers according to this disclosure. FIG. 10 shows a node 100 that is able to provide a plane change for an optical signal, as each fiber is optically connected to each other fiber. The conventional node shown in FIG. 9 comprises fewer connections and may be less flexible compared to the node 100 shown in FIG. 10.

FIGS. 9 and 10 shows all directions and optical connections.

The conventional node, for example, a conventional secondary node, enables switching from a fiber of a degree to any other degree on the same fiber. For 3 degrees and M=2, each WSS has size 1×(#degrees−1+K) where the −1 reflects the lack of necessity to switch signals from a fiber on a degree to the fiber in the reverse direction on the same degree. In this example, K=1 and 1×3 WSS are needed, wherein typically 1×9 WSSs are used.

For the node 100 shown in FIGS. 10, 1×6 WSSs may be needed where 6 is (#degrees*M−1)+K, which can be implemented with a 1×9 WSS. Thus, no hardware replacement may be required. By allowing plane changes at the nodes 100, routing flexibility can be enhanced. For example, see FIG. 5 how the service between Node 1 and Node 3 can now be routed, wherein it was blocked with the stacked architecture shown in FIG. 4. This may reduce network blocking rate during provisioning or rerouting after fiber cuts. If there is no node 100 between two main nodes, a new “main node” or “combined mode” may be formed by appending a node 100 to a main node.

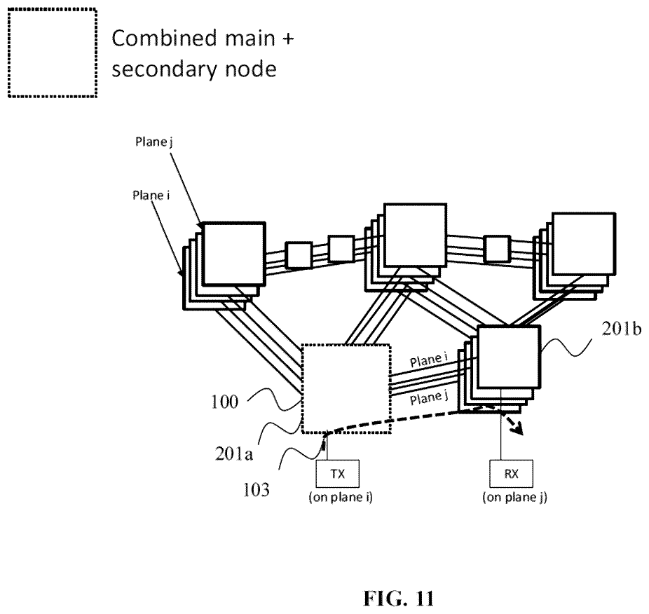

FIG. 11 shows an exemplary combined node in an optical network 200 according to this disclosure. In this example, a service changes plane from plane i to plane j in the combined node. FIG. 11 shows an optical network 200 comprising the combined node 100, 201a, and a second other node 201b, wherein the combined node 100, 201a provides an optical signal 103 from one plane i to another plane j of another optical link 202b of the second other node 201b. In this example, the first other node 201a and the second other node 201b is respectively a other primary node. In this example, a service or optical signal 103 changes plane from plane i to plane j in the secondary node 100 or combined node 100, 201a.

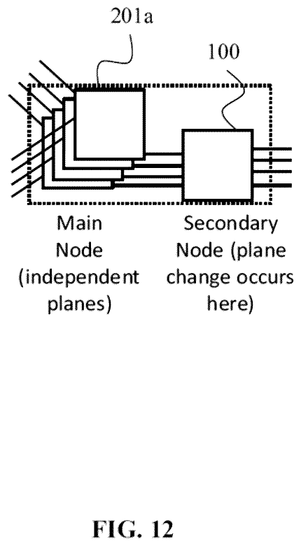

FIG. 12 shows an exemplary combined node according to this disclosure. The main node 201a and the secondary node 100 may be combined as shown in FIG. 12. The combined node may enable switching planes using a conventional main node.

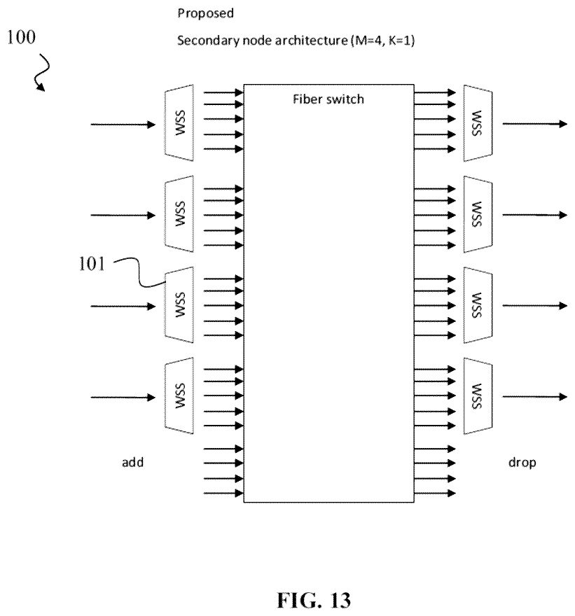

FIG. 13 shows a node 100 comprising a fiber switch according to this disclosure. A node 100 may comprise wiring as exemplary shown in FIG. 10. Such wiring between the input and output WSSs 101 may be replaced with a fiber switch. The fiber switch can route all wavelengths on a given input fiber to an output fiber, simultaneously. A fiber switch may be denoted as OXC (optical cross-connect) and implemented with a MEMS (micro electro-mechanical system). A fiber switch may simplify wiring when building a node 100.

A set of parallel standard (single-core) fibers between two nodes may be replaced with a single multi-core fiber or a multi-mode fiber. A main node implemented as stacked ROADMs, may be replaced with a single, larger ROADM, in case the size (WSS N parameter) permits it.

A main node may be enabled to provide plane switching. This may be limited to cases where the main nodes are sufficiently small to stay within the WSS size constraint. For example, the node 100 may be a main node.

This disclosure may, for example, provide that if a network is already deployed and its capacity is growing, a second network, using new fibers in the same cables as the original network, may be added and new nodes interconnecting the new fibers may be deployed, which results in a stacked network, with aforementioned flexibility drawback. To circumvent this inflexibility, some of the conventional secondary nodes may be replaced with secondary nodes 100 according to this disclosure at selected locations. For example, rewiring of the stacked secondary nodes of a conventional secondary node may be enough to build the secondary node 100. For example, one secondary node per link between two main nodes may be transformed or, in case no secondary node exists between two main nodes, a main node may be transformed into a combined node to enable plane switching.

A network based on the node 100 may require a single control plane and a single control channel network-wide, resulting in operational simplification and lower CAPEX. Conventional parallel (stacked) systems operating several independent networks may require one control plane (software) and one control channel (implemented through boards on each node) per plane.

The controller 105 may be a processor 105. Generally, the processor 105 may be configured to perform, conduct or initiate the various operations of the node 100 described herein. The processor 105 may comprise hardware and/or may be controlled by software. The hardware may comprise analog circuitry or digital circuitry, or both analog and digital circuitry. The digital circuitry may comprise components such as application-related integrated circuits (ASICs), field-programmable arrays (FPGAs), digital signal processors (DSPs), or multi-purpose processors. The node 100 may further comprise memory circuitry, which stores one or more instruction(s) that can be executed by the processor 105, in particular under control of the software. For instance, the memory circuitry may comprise a non-transitory storage medium storing executable software code which, when executed by the processor 105, causes the various operations of the node 100 to be performed. In one embodiment, the node 100 may comprises one or more processors 105 and a non-transitory memory connected to the one or more processors 105. The non-transitory memory may carry executable program code which, when executed by the one or more processors 105, causes the node 100 to perform, conduct or initiate the operations or methods described herein.

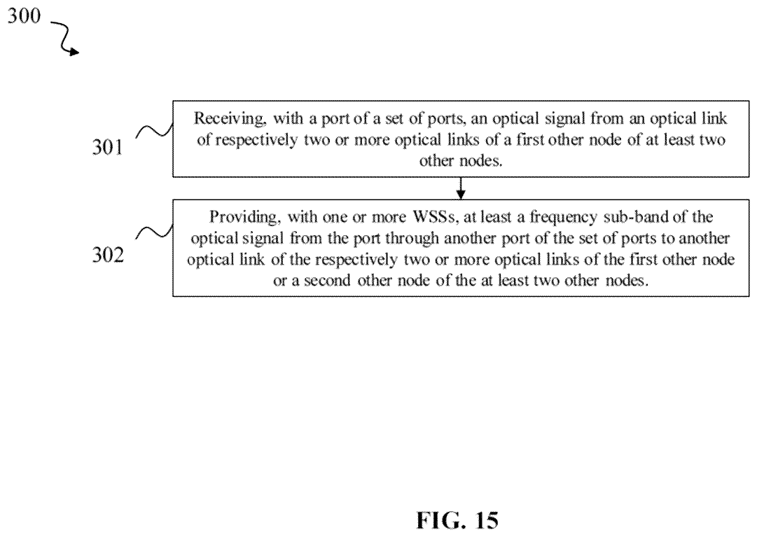

FIG. 15 shows a method 300 according to this disclosure. The method 300 is a method of operating a node 100 for a multi-plane 203 optical network 200, for example, the node 100 shown in FIG. 1, wherein the node 100 is optically connectable, for each other node of at least two other nodes 201 of the multi-plane 203 optical network 200, through respectively two or more optical links to the other node, wherein the node 100 comprises one or more WSSs 101, comprising a set of ports 102.

The method 300 comprises a step 301 of receiving, with a port 102a of the set of ports 102, an optical signal 103 from an optical link 202a of the respectively two or more optical links of a first other node 201a of the at least two other nodes 201, wherein the optical link 202a is associated with one plane 203a of the multi-plane 203 optical network 200. Further, the method 300 comprises a step 302 of providing, with the one or more WSSs 101, at least a frequency sub-band of the optical signal 103a from the port 102a through another port 102b of the set of ports 102 to another optical link 202b of the respectively two or more optical links of the first other node 201a or a second other node 201b of the at least two other nodes 201, wherein the another optical link 202b is associated with one other plane 203b of the multi-plane 203 optical network 200.

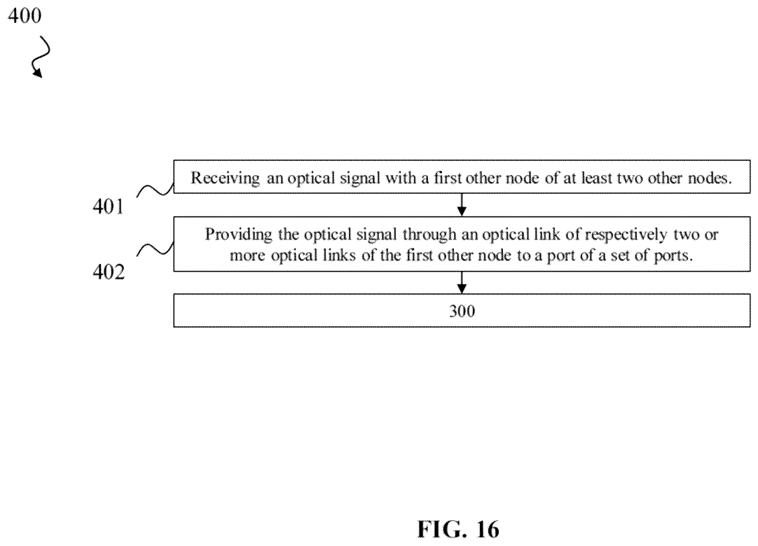

FIG. 16 shows a method 400 according to this disclosure. The method 400 is a method of operating a multi-plane 203 optical network 200, for example, the multi-plane 203 optical network 200 shown in FIG. 14, and comprises the method shown in FIG. 15, wherein the multi-plane 203 optical network 200 comprises the node 100, the at least two other nodes 201, and, for each other node of the at least two other nodes 201, the respectively two or more optical links that optically connect the other node to the node 100.

The method 400 comprises a step 401 of receiving the optical signal 103 with the first other node 201a of the at least two other nodes 201. Further, the method 400 comprises a step 402 of providing the optical signal 103 through the optical link 202a of the respectively two or more optical links of the first other node 201a to the port 102a of the set of ports 102. Further, the method 400 comprises the method 300 of operating the node 100 as shown in FIG. 15.

The disclosure has been described in conjunction with various embodiments as examples as well as implementations. However, other variations can be understood and effected by those persons skilled in the art and practicing the claimed matter, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

What is claimed is:

1. A node for a multi-plane optical network, wherein the node is optically connectable, for each other node of at least two other nodes of the multi-plane optical network, through respectively two or more optical links to the other node, the node comprising:
one or more wavelength selective switches (WSSs) comprising a set of ports,
wherein the node is configured to:
receive, with a port of the set of ports, an optical signal from an optical link of the respectively two or more optical links of a first other node of the at least two other nodes, wherein the optical link is associated with one plane of the multi-plane optical network, and
provide, by the one or more WSSs, at least a frequency sub-band of the optical signal from the port through another port of the set of ports to another optical link of the respectively two or more optical links of the first other node or a second other node of the at least two other nodes, wherein the another optical link is associated with one other plane of the multi-plane optical network.

2. The node according to claim 1,
wherein the one or more WSSs are further configured to provide at least another frequency sub-band of the optical signal from the port through a further port of the set of ports to a further optical link of the respectively two or more optical links of the second other node or a third other node of the at least two other nodes, wherein the further optical link is associated with the one plane of the multi-plane optical network.

3. The node according to claim 2,
wherein the node is further configured to receive, with the port, another optical signal from the optical link,
wherein the one or more WSSs are further configured to provide at least a frequency sub-band of the another optical signal from the port through a further port of the set of ports to a further optical link of the respectively two or more optical links of the second other node or a third other node of the at least two other nodes, wherein the further optical link is associated with the one plane of the multi-plane optical network.

4. The node according to claim 3,
wherein the node further comprises a controller,
wherein the controller is configured to control the one or more WSSs to provide at least one of: at least the frequency sub-band of the optical signal to the another optical link, the at least another frequency sub-band of the optical signal to the further optical link, and at least the frequency sub-band of another optical signal to the further optical link.

5. The node according to claim 4,
wherein the controller is configured to obtain a network traffic routing plan for distributing traffic across a plurality of planes of the multi-plane optical network,
wherein the controller is configured to control the one or more WSSs based on the network traffic routing plan.

6. The node according to claim 1,
wherein the one or more WSSs are configurable to optically connect each port of the set of ports to each other port of the set of ports.

7. The node according to claim 1, comprising at least one of:
the set of ports comprises at least one drop port configured to remove one or more selected wavelengths from the optical signal and provide the one or more selected wavelengths to one or more local receivers at the node; or
the set of ports comprises at least one add port configured to provide one or more additional wavelengths from one or more local transmitters into the at least a frequency sub-band of the optical signal.

8. The node according to claim 1,
wherein the one or more WSSs are configured to provide at least the frequency sub-band of the optical signal from the port through a fiber switch or a plurality of wires, and through the another port to the another optical link.

9. A multi-plane optical network comprising a node, wherein the node is optically connectable, for each other node of at least two other nodes of the multi-plane optical network, through respectively two or more optical links to the other node,
wherein the node comprises:
one or more wavelength selective switches (WSSs) comprising a set of ports,
wherein the node is configured to:
receive, with a port of the set of ports, an optical signal from an optical link of the respectively two or more optical links of a first other node of the at least two other nodes, wherein the optical link is associated with one plane of the multi-plane optical network, and
provide, by the one or more WSSs, at least a frequency sub-band of the optical signal from the port through another port of the set of ports to another optical link of the respectively two or more optical links of the first other node or a second other node of the at least two other nodes, wherein the another optical link is associated with one other plane of the multi-plane optical network,
wherein the optical network is configured to:
receive the optical signal with the first other node of the at least two other nodes, and
provide the optical signal through the optical link of the respectively two or more optical links of the first other node to the port of the set of ports.

10. The optical network according to claim 9,
wherein the optical network is further configured to provide at least the frequency sub-band of the optical signal through the another optical link to the first other node or the second other node.

11. The optical network according to claim 9,
wherein the at least two other nodes comprise one or more other secondary nodes.

12. The optical network according to claim 11,
wherein the one or more other secondary nodes comprise a plurality of sub-nodes that are optically isolated from each other in respectively the other secondary node, each sub-node being associated with a respective plane of the multi-plane optical network, and/or
wherein the one or more other secondary nodes comprise one or more nodes.

13. The optical network according to claim 9,
wherein the at least two other nodes comprise one or more other primary nodes, each other primary node comprising a plurality of sub-nodes that are optically isolated from each other in respectively the other primary node, each sub-node being associated with a respective plane of the multi-plane optical network.

14. The optical network according to claim 13,
wherein the one or more other primary nodes comprise at least one of: the first other node, the second other node, and a third other node.

15. The optical network according to claim 13,
wherein the node is embedded with a other primary node of the one or more other primary nodes forming a combined node.

16. The optical network according to claim 13,
wherein each node of the one or more other primary nodes has higher traffic than the node and/or each node of one or more other secondary nodes.

17. A method of operating a node for a multi-plane optical network, wherein the node is optically connectable, for each other node of at least two other nodes of the multi-plane optical network, through respectively two or more optical links to the other node,
wherein the node comprises one or more wavelength selective switches (WSSs) comprising a set of ports, and
wherein the method comprises:
receiving, with a port of the set of ports, an optical signal from an optical link of the respectively two or more optical links of a first other node of the at least two other nodes, wherein the optical link is associated with one plane of the multi-plane optical network' and
providing, with the one or more WSSs, at least a frequency sub-band of the optical signal from the port through another port of the set of ports to another optical link of the respectively two or more optical links of the first other node or a second other node of the at least two other nodes, wherein the another optical link is associated with one other plane of the multi-plane optical network.
